(19) United States
(12) Patent Application Publication
(10) Pub. No.: US 2008/0089716 A1
(43) Pub. Date: Apr. 17, 2008

(54) Color Image Processing Method, Color Image Forming Apparatus and Color Image Processing Program

(75) Inventor: Yutaka Hosono, Kawasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/676,531

(22) Filed: Feb. 20, 2007

(30) Foreign Application Priority Data
Oct. 13, 2006 (JP) 2006-279947

(51) Int. Cl. G03G 15/01

(52) U.S. Cl. 399/223

(57) ABSTRACT

There is described a color image forming method, a color image forming apparatus, and an image forming program, which make it possible to reduce the amount of colorant consumption to a level lower than ever. The color image forming apparatus includes: a first image data converting section to replace achromatic color components included in color image data constituted by color components of Yellow (Y), Magenta (M), Cyan (C) with a first color component of Black (Bk); and a second image data converting section to replace at least a part of any one or any two of residual color components of Yellow (Y), Magenta (M), Cyan (C), which still remain after the achromatic color components are replaced with the first color component of Black (Bk), with a second color component of Black (Bk).

This application is based on Japanese Patent Application No. 2006-279947 filed on Oct. 13, 2006 with Japan Patent Office, the entire content of which is hereby incorporated by reference.

### BACKGROUND

The present invention relates to a color image processing method, a color image forming apparatus and a color image processing program, for generating color image data, by replacing color components with each other.

In the image forming apparatus for forming a color image onto a sheet by employing a colorant, such as toner, ink, etc., the color image represented by colors Red (R), Green (G), and Blue (B) is formed on the sheet by employing the colorants of colors Yellow (Y), Magenta (M), Cyan (C) and the colorant of color Black (Bk).

When forming the color image onto the sheet in the abovementioned manner, it is necessary to convert image data of colors R, G, B to image data of colors Y, M, C, and Bk. Initially, the three dimensional color converting operation is applied to the image data of colors R, G, and B, in order to convert the image data of colors R, G, and B to the image data of colors Y, M, C, and Bk. Then, with respect to the achromatic color components (gray components) of the image data of colors Y, M, and C, the UCR (Under Color Removal) processing, for replacing a part or all of the achromatic color components with Bk component, has been frequently applied (refer to Patent Document 1 (Tokkaihei 5-207276, Japanese Non-Examined Patent Publication)).

By applying the UCR processing, it becomes possible to reduce an amount of colorant consumption. Further, generally speaking, since an image quality can be improved by reproducing the grey gradation with the colorant of color Bk, rather than the mixture of the colorants of colors Y, M, and C, an improvement of the image quality can be also attained by applying the UCR processing.

However, since a reducible amount of colorant consumption varies depending on a kind of color image to be reproduced when employing the UCR processing of general purpose, the user who wishes to sufficiently reduce the amount of colorant consumption has not necessary satisfied sufficiently with the conventional UCR processing of general purpose.

### SUMMARY

To overcome the abovementioned drawbacks in conventional color image forming apparatus, it is one of objects of the present invention to provide a color image forming method, a color image forming apparatus, and an image forming program, which make it possible to reduce the amount of colorant consumption to a level lower than ever.

Accordingly, at least one of the objects of the present invention can be attained by the color image forming methods described as follows.
(1) According to a color image processing method reflecting an aspect of the present invention, in the color image processing method, all of achromatic color component and at least a part of component other than the achromatic color component, both included in color image data constituted by color components of Yellow (Y), Magenta (M), Cyan (C) are replaced with a color component of Black (Bk) to generate processed color image data constituted by at most two of the color components of Y, M, and C, and the color component of Bk.
(2) According to a color image processing method reflecting another aspect of the present invention, the color image processing method, comprises: a first step of replacing achromatic color component included in color image data constituted by color components of Yellow (Y), Magenta (M), Cyan (C) with a component of Black (Bk); and a second step of replacing at least a part of residual color components of Y, M, and C, which still remain after the achromatic color components are replaced with the color component of Bk, with the component of Bk.
(3) According to still another aspect of the present invention, in the color image processing method recited in item 2, when a total sum value of the residual color components of Y, M, and C exceeds a predetermined value, the second step is implemented.
(4) According to still another aspect of the present invention, in the color image processing method recited in item 2, the first step and the second step are implemented for every pixel represented by the color image data.
(5) According to yet another aspect of the present invention, the color image processing method recited in item 2 further comprises: a third step of generating the color image data constituted by color components of Y, M, and C from original color image data constituted by color components of Red (R), Green (G), and Blue (B); wherein the third step is implemented preceding to the first step.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a center cross sectional block diagram of an internal configuration of a color image forming apparatus embodied in the present invention;

FIG. 2 shows a block diagram of a control system of a color image forming apparatus embodied in the present invention;

FIG. 3 shows an explanatory drawing of a setting screen in a printer driver;

FIG. 4 shows a flowchart for explaining a color conversion processing when the “COLOR” mode is selected;

FIGS. 5(a), 5(b) and 5(c) are explanatory drawings indicating an example of an amount of toner consumption when forming an image based on image data;

FIG. 6 shows a flowchart for explaining a color conversion processing when a “DRAFT COLOR” mode is selected;

FIGS. 7(a) through 7(f) are explanatory drawings indicating an example of an amount of toner consumption when forming an image based on image data; and

FIGS. 8(a) through 8(f) are explanatory drawings indicating an example of an amount of toner consumption when forming an image based on image data.

### DETAILED DESCRIPTION OF THE PREFERRED EMBODIMENT

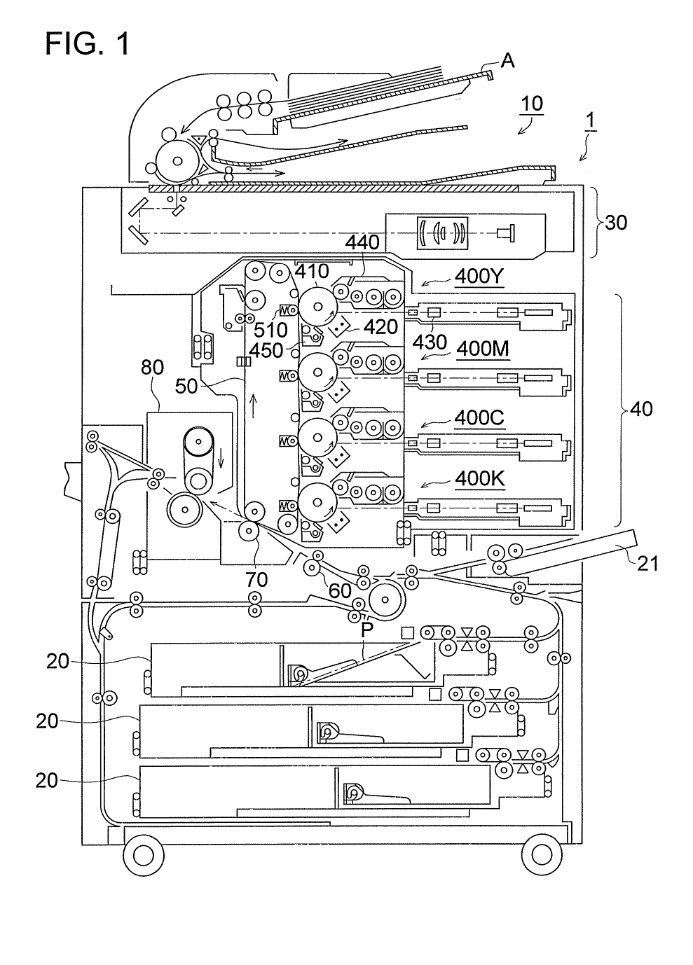

FIG. 1 is a cross sectional view of a color image forming apparatus 1 showing the internal configuration thereof.

The color image forming apparatus 1 is a tandem-type color image forming apparatus provided with an intermediate transfer belt 50.

A document stacked on a document feeding tray A of an automatic duplex-document feeder 10 is conveyed to an image reading section 30 by various kinds of rollers.

The color image forming apparatus 1 is provided with a plurality of recording medium accommodating sections 20 disposed at its lower space. Provided above the recording medium accommodating sections 20 are an image forming section 40 and an intermediate transfer belt 50. Further, an image reading section 30 is provided at the top of the main body.

A recording medium accommodating section 20, being one of the plurality of recording medium accommodating sections 20, is mounted, so as to be drawn towards the front side of the color image forming apparatus 1 (namely, in a paper surface frontward direction of the FIG. 1). Various kinds of different-sized standard paper sheets serving as the recording mediums, such as white papers, etc., are divided according to the different standard sizes and accommodated into the plurality of recording medium accommodating sections 20. Special sheets, such as OHP sheets, etc., are stacked onto a manual insertion tray 21.

An image forming section 40 includes four sets of image forming engines 400Y, 400M, 400C, and 400K for forming unicolor toner images of color Y (Yellow), color M (Magenta), color C (Cyan) and color K (Black), respectively. The image forming engines 400Y, 400M, 400C, and 400K are linearly arranged in this order of an up-to-down direction, and have the same configuration. Accordingly, for explaining the configuration, the image forming engine 400Y is exemplified in the following.

The image forming engine 400Y is provided with a photoreceptor drum 410 rotating in a counterclockwise direction, a scorotron charging device 420, an exposing device 430 and a developing device 440.

A cleaning section 450 is disposed at a lower space of the photoreceptor drum 410 in such a manner that the cleaning section 450 includes an area opposing to the lowest section of the photoreceptor drum 410.

The intermediate transfer belt 50, disposed in a center space of the color image forming apparatus itself, is formed in an endless-belt shape, and has a predetermined volume resistivity. Further, a primary transferring electrode 510 is disposed at such a position that opposes to the photoreceptor drum 410 while putting the intermediate transfer belt 50 therebetween.

Next, the color image forming method for forming the color image will be detailed in the following.

The scorotron charging device 420 uniformly charges the circumferential surface of the photoreceptor drum 410 at a voltage having a negative polarity (for instance, −800 Volts) with its discharging action, while the photoreceptor drum 410 is driven to rotate by a main motor (not shown in the drawings). Then, the exposing device 430 exposes the photoreceptor drum 410 with a light beam modulated by image information, so as to form an electrostatic latent image corresponding to the image information on the photoreceptor drum 410. Successively, when the electrostatic latent image formed on the photoreceptor drum 410 passes through the developing device 440, the yellow toner charged at the negative voltage in the developing device 440 is attracted and adhered to an area of the latent image by applying a negative developing bias to the area, so as to form a Y toner image on the photoreceptor drum 410. The Y toner image formed on the photoreceptor drum 410 is transferred onto the intermediate transfer belt 50, which press-contacts the photoreceptor drum 410. After the abovementioned transferring operation, the residual toner remaining on the photoreceptor drum 410 are cleaned by the cleaning section 450. The separate unicolor toner images respectively formed in the image forming engines 400Y, 400M, 400C, and 400K are sequentially transferred one by one onto the intermediate transfer belt 50 in such a manner that the separate unicolor toner images are superimposed on each other, so as to form a full color toner image on the intermediate transfer belt 50. A recording medium P is picked up one by one from the plurality of recording medium accommodating sections 20 and conveyed to the position of a pair of registration rollers 60. After the leading edge of the recording medium P is trued by butting it against the pair of registration rollers 60, the pair of registration rollers 60 commences to convey the recording medium P at such a timing that the position of the full color toner image residing on the intermediate transfer belt 50 coincides with that on the recording medium P. The recording medium P, conveyed by the pair of registration rollers 60, is guided by a guide plate, so that the recording medium P can be fed into a transferring nip section formed between the intermediate transfer belt 50 and a secondary transferring section 70. The secondary transferring section 70, including a pair of rollers, press-pushes the recording medium P against the intermediate transfer belt 50. By applying a bias voltage having a polarity opposite to that of the toner image (for instance, +500 Volts) to the secondary transferring section 70, the full color toner image residing on the intermediate transfer belt 50 is transferred onto the recording medium P. The recording medium P is discharged by a separating device including a discharging needle (not shown in the drawings), to separate the recording medium P from the secondary transferring section 70, and conveyed into a fixing section constituted by a pair of a heating roller and a pressing roller. As a result, the full color toner image is fixed onto the recording medium P, and the recording medium P on which the image is already formed, is ejected outside the color image forming apparatus 1.

Incidentally, although the color image forming apparatus shown in FIG. 1 employs the electro-photographic method, it is also applicable that the color image forming apparatus employs any other image forming method (for instance, the ink-jet printing method).

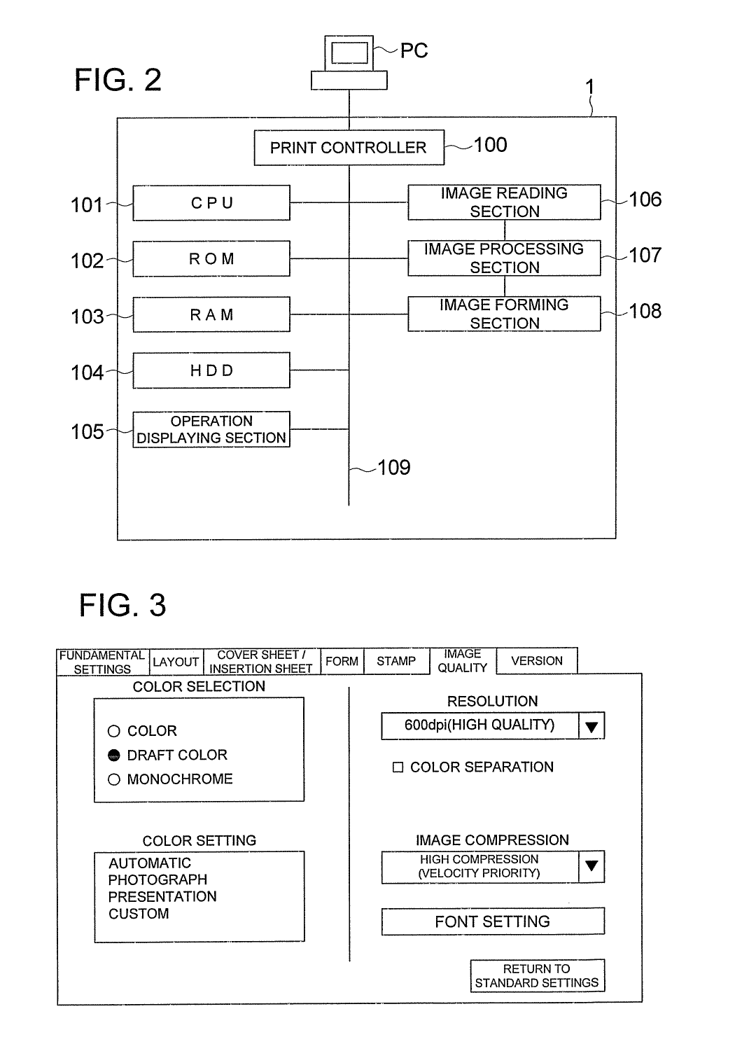

FIG. 2 shows a block diagram of a control system of the color image forming apparatus 1 embodied in the present invention.

A CPU (Central Processing Unit) 101, serving as a calculating section and a controlling section in this embodiment, controls an overall operation of the color image forming apparatus 1, and is coupled to a ROM (Read Only Memory) 102, a RAM (Random Access Memory) 103, etc. through a system bus 109. The CPU 101 reads out various kinds of control programs stored in the ROM 102, and develops the control program into the RAM 103, in order to control the operations of the concerned sections. Further, the CPU 101 executes the control program developed into the RAM 103 in order to conduct various kinds of processing, and stores the results of the processing into the RAM 103 and displays them on an operation displaying section 105. In addition, the CPU 101 stores the results of the processing, temporally stored in the RAM 103, into other predetermined storage destinations.

The ROM 102 stores the programs, the data, etc. in advance, and is constituted by a magnetic recording medium, an optical recording medium or a semiconductor storage device. The image forming program is stored in the ROM 102, so that the color image forming apparatus 1 implements the image forming operations based on the color image processing program concerned.

The RAM 103 forms a working area in which the data, etc., processed by executing the various kinds of programs to be executed by the CPU 101, are temporally stored.

An HDD (Hard Disc Drive) 104 has a function for storing the image data acquired by reading the document image from an image reading section 106 and other image data based on which the image is already outputted. The HDD 104 is constituted by a plurality of metallic or glass discs onto each of which a magnetic material is coated or vapor-deposited and which are arranged in parallel at constant intervals in an overlapping state. The data accessing operation is achieved by making magnetic heads approach the surfaces of plurality of metallic discs, which are currently rotating at a high velocity.

Various kinds of setting items can be inputted and established from the operation displaying section 105. The operation displaying section 105 is formed in, for instance, a touch panel type configuration, so that the user can easily conduct inputting operations for establishing the conditions of the color printing operation or the monochrome printing operation. Further, various kinds of information, such as network setting information, etc., are displayed on the operation displaying section 105.

The image reading section 106 optically reads the document image, and converts the optical signals to electric signals. When reading a color document image, the image reading section 106 generates image data in which luminance data of 10 bits are allotted to each of RGB colors for every one pixel.

An image processing section 107, serving as a first image data converting section and a second image data converting section, applies image processing to the image data generated by the image reading section 106 and other image data transmitted from a personal computer coupled to the color image forming apparatus 1. When the color printing operation is conducted in the color image forming apparatus 1, image data of color R (Red), color G (Green) and color B (Blue) generated by the image reading section 106 are inputted into the color conversion LUT (Look Up Table) in the image processing section 107, in order to converts the image data of colors R, G, and B to other image data of color Y (Yellow), color M (Magenta), color C (Cyan) and color Bk (Black). Then, the image processing section 107 applies various kinds of image processing, such as a compensation for the gradation reproducing characteristics, a screen processing of dot matrix conducted by referring to the density correction LUT, an edge processing for enhancing the slim lines, etc., to the converted image data of colors Y, M, C, and Bk.

An image forming section 108 receives the processed image data, to which the image processing section 107 applied the image processing, and forms an image on a sheet based on the processed image data.

FIG. 3 shows an explanatory drawing of a setting screen in the printer driver.

The setting screen shown in FIG. 3 is displayed on the display screen of the personal computer coupled to the color image forming apparatus 1. Various kinds of printing conditions are settable through this setting screen. The setting screen is provided with various kinds of tabs, and, when the tab of “IMAGE QUALITY” is selected, it becomes possible to set the setting items of “COLOR SELECTION”, “COLOR SETTING”, “RESOLUTION”, etc.

In the setting item of “COLOR SELECTION”, it is possible to select any one of three separate modes, including “COLOR” being the first image processing mode, “DRAFT COLOR” being the second image processing mode, “MONOCHROME” being the third image processing mode. When any one of the three separate modes is selected, a signal corresponding to the selected one is notified to the CPU 101, so that CPU 101 can change the current mode to the selected mode. The CPU 101 sets the image forming velocity, the developing bias voltage, etc. in each of the three separate modes. The first image forming velocity in the “COLOR” mode is set at 185 mm/sec. (the value with respect to the paper sheet conveyance velocity), the second image forming velocity in the “DRAFT COLOR” mode is set at 216 mm/sec. (the value with respect to the paper sheet conveyance velocity) and the third image forming velocity in the “MONOCHROME” mode is set at 230 mm/sec. (the value with respect to the paper sheet conveyance velocity). The second image forming velocity set for the “DRAFT COLOR” mode is greater than the first image forming velocity set for the “COLOR” mode, while the third image forming velocity set for the “MONOCHROME” mode is greater than the second image forming velocity set for the “DRAFT COLOR” mode.

When the “COLOR” mode is selected, the normal color printing operation is performed. On the other hand, when the “DRAFT COLOR” mode is selected, adjustments are conducted in the color conversion processing, in order to implement a special color printing operation, which makes it possible to reduce an amount of toner consumption to a level lower than that of the normal color printing operation when reproducing a high-density image. Concretely speaking, any one of the two color printing modes is selectable in the color image forming apparatus 1, and specifically, in the color printing operation of the “DRAFT COLOR” mode, not only the amount of toner consumption is small, but also the image forming velocity is high, compared to those in the color printing operation of the “COLOR” mode. When the “MONOCHROME” mode is selected, the monochrome printing operation is implemented by employing the black toner only. Incidentally, it is also applicable that the operation displaying section 105 is made to display such the setting screen as shown in FIG. 3 on it. According to this configuration, even for a copy operation of the color document, it becomes possible to set any one of the “COLOR” and “DRAFT COLOR” modes, etc., as well.

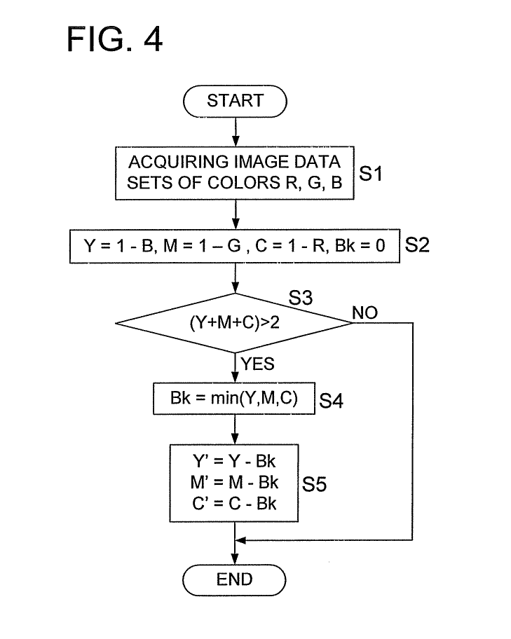

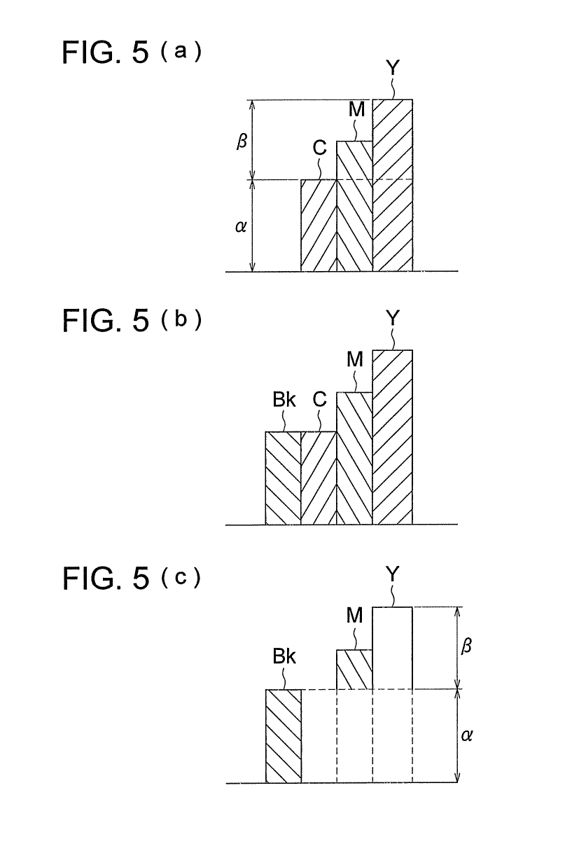

Referring to FIG. 4, and FIGS. 5(a), 5(b) and 5(c), a color image forming method, to be implemented by employing the setting screen shown in FIG. 3 when the “COLOR” mode is selected, will be detailed in the following.

FIG. 4 shows a flowchart for explaining the color conversion processing when the “COLOR” mode is selected, while FIG. 5(a), FIG. 5(b) and FIG. 5(c) are explanatory drawings indicating an example of an amount of toner consumption when forming an image based on image data.

When the “COLOR” mode is selected by using the setting screen shown in FIG. 3, the image processing section 107 implements the color conversion processing according to the flowchart shown in FIG. 4. The CPU 101 reads out an color image processing program from the ROM 102 and stores it into the RAM 103, so as to implement the operations according to the flowchart shown in FIG. 4 by executing the color image processing program stored in the RAM 103. Herein, when assuming that a black solid image is printed at a maximum density, total 300% of toner, including 100% of Yellow toner, 100% of Magenta toner, 100% of Cyan toner, is consumed at maximum. However, in the present embodiment, the maximum amount of toner consumption for the color printing operation is established at a value being twice of the maximum amount of toner consumption for a single color, namely, at 200%. This is because, the toner residing on the paper sheet is made to stably fix onto the paper sheet without causing any toner peeling-off defect, etc., in the fixing section of the color image forming apparatus 1. As will be detailed in the following, in order to limit the maximum amount of toner consumption to 200%, the image processing section 107 performs the UCR processing (Under Color Removal processing) in the color image forming apparatus 1 embodied in the present invention.

Now, the flowchart shown in FIG. 4 will be detailed in the following. Initially, the image processing section 107 acquires the image data including components of colors R, G, B (Step S1). The image processing section 107 acquires the image data including the components of colors R, G, B from the image reading section 106 or the personal computer coupled to the color image forming apparatus 1.

Next, in order to implement the color printing operation in the image forming section 108, the image processing section 107 conducts the color conversion processing for converting the image data including components of colors R, G, B to converted image data including components of colors Y, M, C, and Bk for every pixel (third step). In order to implement the color printing operation, an image data set for color Bk is established at zero, while other image data for colors Y, M, and C are calculated by employing the equations indicated as follow (Step S2).

Y=1−B, M=1−G, C=1−R

Herein, it is assumed, for instance, that amounts of toner consumptions calculated for a certain pixel based on the image data of colors Y, M, and C are such values as indicated in FIG. 5(a).

Next, a total value of the image data of colors Y, M, and C is found by adding them to each other, so as to determine whether or not the total value exceeds 2 (being a value corresponding to 200% of toner consumption) (Step S3). When the total value is equal to or smaller than 2, it is possible to implement the color printing operation without generating any problem, and accordingly, the color conversion processing to be conducted by the image processing section 107 is finalized.

On the other hand, when the total value exceeds 2, the amount of toner consumption exceeds its upper limit, and accordingly, the image processing section 107 conducts the adjustment (UCR processing) for replacing at least part of the image data for colors Y, M, and C with the image data for color Bk. Value a (being equal to a level equivalent to the smallest one among the colors Y, M, and C) shown in FIG. 5(a) is equivalent to an achromatic color component of the color image data, while value β shown in FIG. 5(a) is equivalent to an component of the color image data other than the achromatic color component. In the UCR processing, the achromatic color component of the color image data, indicated by value α, is replaced with the image data set for color Bk.

At first, the image data for color Bk is made to match with the smallest one among the image data for colors Y, M, and C (Step S4). Explaining with reference to FIG. 5(b), since the smallest one among the image data for colors Y, M, and C is the image data of color C, the image data set for color Bk is made to match with the image data of color C.

Next, the values derived by subtracting the image data of color Bk from the original image data of colors Y, M, and C are established as new image data (except image data of color Bk) (Step S5). Provided that the original image data are defined as Y, M, and C, while the new image data are defined as Y′, M′, and C′, the new image data are calculated by employing the equations indicated as follow.

Y′=Y−Bk, M′=M−Bk, C′=C−Bk

Explaining with reference to FIG. 5(c), the amount of toner consumption of the new image data set for color C becomes zero, while the amounts of toner consumptions of the new image data for colors Y and M is calculated as differential values between those for colors Y and M and that for color Bk. The total value of the substituted values becomes equal to the amount of color Bk component. 22 8068 Accordingly, if the black unicolor image is reproduced with toner of color Bk based on the abovementioned image data of color Bk, no problem for the color reproducibility would occur. Further, since a total amount of toner consumption can be effectively suppressed as a whole, it becomes possible to stably fix the toner onto the paper sheet. Still further, since the processing as mentioned above are conducted for every pixel residing all over the image, it becomes possible to reduce the total amount of toner consumption to a level equal to or lower than 200% of that in the monochrome image forming mode as a whole image, even in the color printing operation of the “COLOR” mode. Accordingly, even if the image forming operation is conducted at the image forming velocity of 185 mm/sec, it becomes possible to form a good dolor image without generating any fixing defect.

As shown in FIG. 4 and FIGS. 5(a) throuhg 5(c), it is possible to reduce the amount of toner consumption (or the amount of colorant consumption) by employing the UCR processing for replacing the achromatic color component of the color image data with the image data set for color Bk. However, sometimes, further reduction of the amount of toner consumption (or the amount of colorant consumption) is required. To cope with such the needs, the “DRAFT COLOR” mode could be selected so as to conduct the adjustment in which component β of the color image data other than the achromatic color component is also replaced with the image data set for color Bk. This adjustment will be detailed in the following.

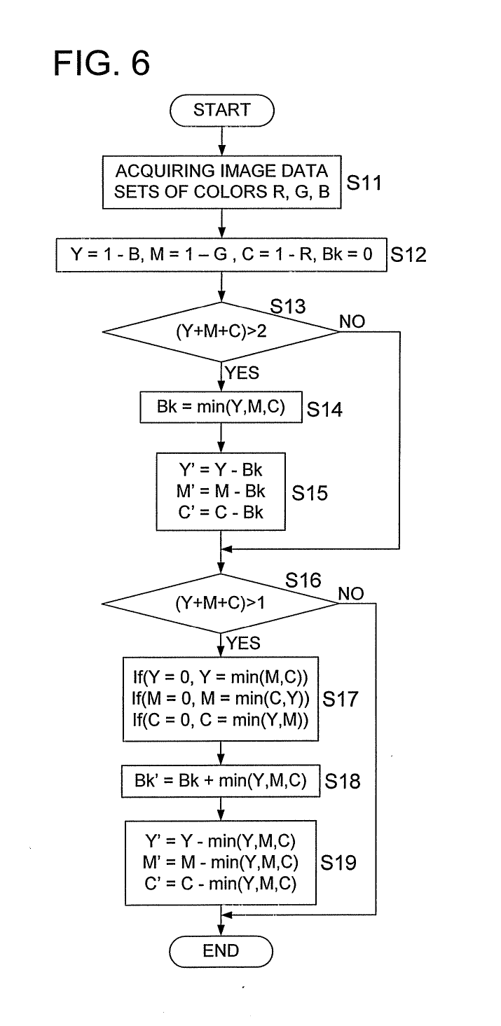

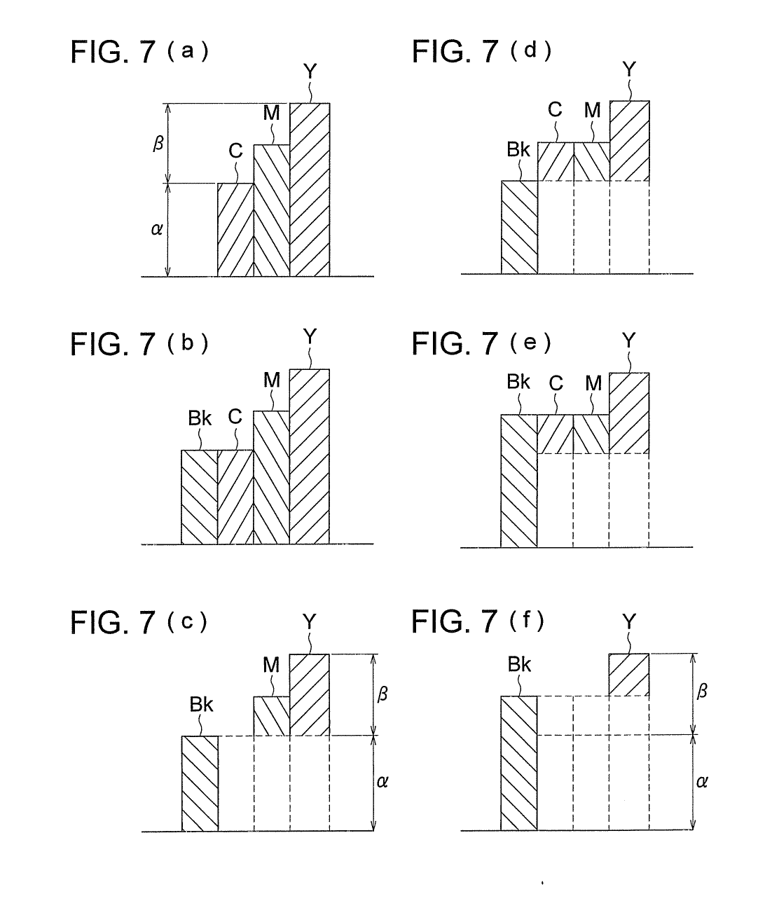

Referring to FIG. 6, and FIGS. 7(a) through 7(f), a color image forming method, to be implemented by employing the setting screen shown in FIG. 3 when the “DRAFT COLOR” mode is selected, will be detailed in the following.

FIG. 6 shows a flowchart for explaining the color conversion processing when the “DRAFT COLOR” mode is selected, while FIGS. 7(a) through 7(f) are explanatory drawings indicating an example of an amount of toner consumption when forming an image based on image data.

When the “DRAFT COLOR” mode is selected by using the setting screen shown in FIG. 3, the image processing section 107 implements the color conversion processing according to the flowchart shown in FIG. 6. The CPU 101 reads out a color image processing program from the ROM 102 and stores it into the RAM 103, so as to implement the operations according to the flowchart shown in FIG. 6 by executing the color image processing program stored in the RAM 103. In the “DRAFT COLOR” mode, the maximum amount of toner consumption for the color printing operation is established at a value being equal to the maximum amount of toner consumption for a single color, namely, at 100%.

Step S11 through Step S15 indicated in FIG. 6 are the same as Step S1 through Step S5 indicated in FIG. 4, and FIGS. 7(a) through 7(c) are the same as FIGS. 5(a), b) and 5(c). In other words, in Step S11 through Step S15, the color conversion processing is conducted by employing the UCR processing in such a manner that the achromatic color component α of the color image data is replaced with the image data set for color Bk (first step) and the maximum amount of toner consumption for a single pixel is made to be equal to or smaller than twice of the maximum amount of toner consumption for the single pixel of a single color, namely, 200%.

Next, a total value of the image data for colors Y, M, C is found by adding them to each other, so as to determine whether or not the total value exceeds the predetermined value of 1 (being a value corresponding to 100% of toner consumption) (Step S16). The CPU 101 conducts the adding calculation of the image data for colors Y, M, and C.

When the total value is equal to or smaller than 1, it is possible to implement the color printing operation at a high image forming velocity, and accordingly, the color conversion processing to be conducted by the image processing section 107 is finalized.

On the other hand, when the total value exceeds 1, since the amount of toner consumption exceeds its upper limit, the amount of toner consumption is further reduced. Accordingly, the image processing section 107 conducts the adjustment for replacing at least a part of the image data for colors Y, M, and C with the image data for color Bk. In Step S11 through Step S15 shown in FIG. 6, by employing the UCR processing, the achromatic color component α of the color image data has been replaced with the image data set for color Bk. Further, the adjustment in which component β of the color image data other than the achromatic color component is also replaced with the image data set for color Bk, is conducted in Step S17 through Step S19 (second step).

At first, when image data for a specific color among colors Y, M, and C is zero, the level of the image data for the specific color is made to match with that of image data for another color, which is smaller one among the image data for colors other than the specific color (Step S17). For instance, when the image data for color Y is zero, the level of the image data for color Y is made to match with that of image data for another color, which is smaller one among the image data for colors M and C. Explaining with reference to FIG. 7(d), since the image data set for color C is zero, the level of the image data for color Y is made to match with that of the image data for color M.

Then, a value derived by adding the image data for one of colors Y, M, and C, having the smallest level among them, to the original image data for color Bk is established as a new image data for color Bk (Step S18), as indicated in FIG. 7(e).

Successively, the values derived by subtracting one of the image data for colors Y, M, and C, having the smallest level among them, from the original image data of colors Y, M, and C (except image data of color Bk) are established as new image data (except image data of color Bk) (Step S19). Provided that the original image data are defined as Y, M, and C, while the new image data are defined as Y′, M′, and C′, the new image data are calculated by employing the equations indicated as follow.

Y′=Y−min(Y, M, C),

M′=M−min(Y, M, C),

C′=C−min(Y, M, C)

Explaining with reference to FIG. 7(f), the amounts of toner consumptions of the new image data for colors C and M become zero, while the amount of toner consumption of the new image data for color Y is calculated as differential values between those for colors C and M and that for color Y. The subtracted image data (min(Y, M, C)) becomes the color Bk component.

In other words, when the “draft color” mode is selected, as shown in FIGS. 7(a) and 7(f), the achromatic color component α and component β other than the achromatic color component is replaced with the image data set for color Bk so as to generate the image data constituted by color components Y (Yellow) and Bk (Black). By conducting such the replacing operation, it becomes possible not only to further reduce the amount of toner consumption (the amount of colorant consumption), but also to stably fix the toner image onto the sheet.

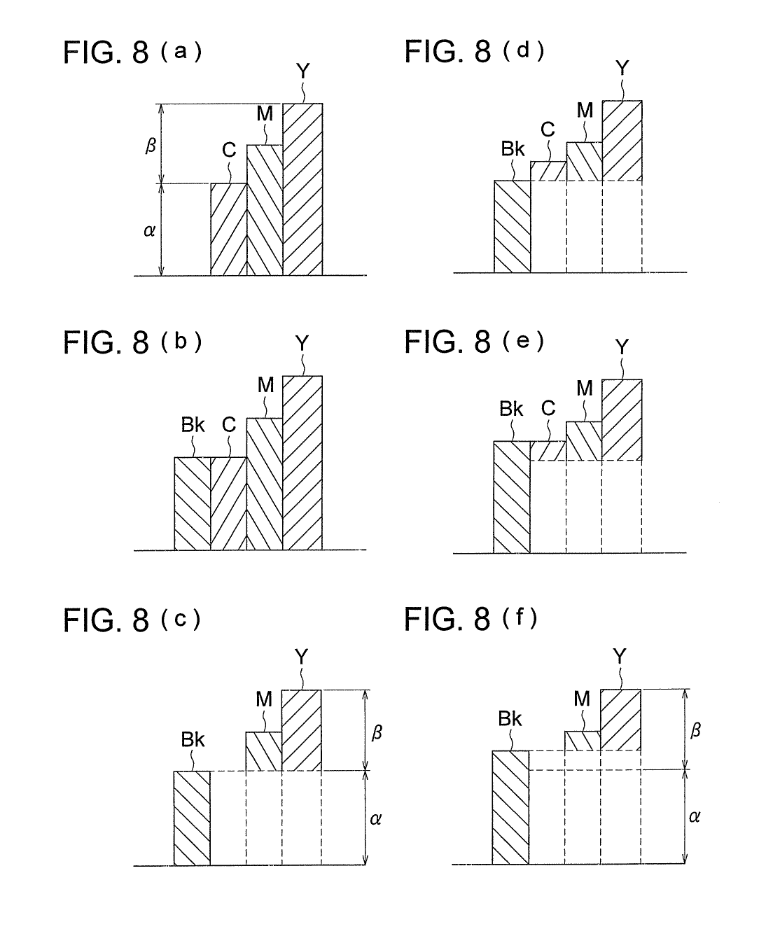

Further, as shown in FIGS. 8(a) through 8(f), it is also applicable that ½ of the part of the image data set of color M corresponding to component β other than the achromatic color component, shown in FIG. 8(c), is replaced with the image data set for color Bk. Concretely speaking, in the process shown in FIGS. 8(a) through 8(f), the achromatic color component α and component β other than the achromatic color component, both included in the color image data constituted by the image data for colors Y, M, and C, are replaced with the image data set for color Bk, so as to generate the processed color image data constituted by two color components of Y and M and color component of Bk.

By applying such the processing as described by referring FIG. 6 through FIG. 8(f) to every pixel residing all over the image, it becomes possible to suppress the total amount of toner consumption for forming all over the image to a level equal to or lower than the maximum amount of toner consumption for a single color image, namely, 100%.

Comparing the “COLOR” mode and the “DRAFT COLOR” mode with each other, the color printing operation is possible in the both modes, and, by selecting the “DRAFT COLOR” mode, it becomes possible not only to further reduce the amount of toner consumption (amount of colorant consumption), but also to increase the velocity of the color printing, without generating any considerable obstruction for the color reproducibility.

In the foregoing, the embodiments of the present invention have been described by referring to the drawings. However, the scope of the present invention is not limited to the aforementioned embodiments. Related embodiments to be possibly derived form the aforementioned embodiments by a skilled person without departing from the spirit and scope of the present invention shall be included in the scope of the present invention.

According to the color image processing method, the color image forming apparatus and the color image processing program embodied in the present invention, it becomes possible to further reduce the amount of colorant consumption, compared to that consumed by employing the conventional UCR processing.

While the preferred embodiments of the present invention have been described using specific term, such description is for illustrative purpose only, and it is to be understood that changes and variations may be made without departing from the spirit and scope of the appended claims.

What is claimed is:

1. A color image processing method,
wherein all of achromatic color component and at least a part of component other than the achromatic color component, both included in color image data constituted by color components of Yellow (Y), Magenta (M), and Cyan (C) are replaced with a color component of Black (Bk) to generate processed color image data constituted by at most two of the color components of Y, M, and C, and the color component of Bk.

2. A color image processing method, comprising:
a first step of replacing achromatic color component included in color image data constituted by color components of Yellow (Y), Magenta (M), and Cyan (C) with a component of Black (Bk); and
a second step of replacing at least a part of residual color components of Y, M, and C, which still remain after the achromatic color components are replaced with the color component of Bk, with the component of Bk.

3. The color image processing method of claim 2,
wherein, when a total sum value of the residual color components of Y, M, and C exceeds a predetermined value, the second step is implemented.

4. The color image processing method of claim 2,
wherein the first step and the second step are implemented for every pixel represented by the color image data.

5. The color image processing method of claim 2, further comprising:
a third step for generating the color image data constituted by color components of Y, M, and C from original color image data constituted by color components of Red (R), Green (G), Blue (B);
wherein the third step is implemented preceding to the first step.

6. A color image processing apparatus, comprising:
a first image data converting section to replace achromatic color components included in color image data constituted by color components of Yellow (Y), Magenta (M), and Cyan (C) with a color component of Black (Bk); and
a second image data converting section to replace at least a part of residual color components of Y, M, and C, which still remain after the achromatic color components are replaced with the color component of Bk, with the color component of Bk.

7. The color image processing apparatus of claim 6, further comprising:
a calculating section to calculate a total sum value of the residual color components of Y, M, and C; and
a control section to control the second image data converting section so that the second image data converting section replaces at least the part of the residual color components of Y, M, and C with the color component of Bk, when the total sum value calculated by the calculating section exceeds a predetermined value.

8. The color image processing apparatus of claim 6,
wherein the first image data converting section replaces the achromatic color components included in the color image data for every pixel represented by the color image data, and the second image data converting section replaces at least the part of the residual color components of Y, M, and C for every pixel represented by the color image data.

9. The color image processing apparatus of claim 6, further comprising:
an image data processing section to apply image data conversion processing to original color image data constituted by color components of Red (R), Green (G), and Blue (B), so as to generate the color image data constituted by color components of Y, M, and C from the original color image data.

10. A computer-readable storage medium that stores a color image processing program with which a color image forming apparatus implements a processing operation of color image data comprising:
a first step of replacing achromatic color component included in color image data constituted by color components of Yellow (Y), Magenta (m),land Cyan (C) with a color component of Black (Bk); and
a second step of replacing at least a part of residual color components of Y, M, and C, which still remain after the achromatic color component is replaced with the color component of Bk, with the color component of Bk.

11. The computer-readable storage device of claim 10,
wherein, when a total sum value of the residual color components of Y, M, and C exceeds a predetermined value, the second step is executed.

12. The computer-readable storage device of claim 10,
wherein the first step and the second step are executed for every pixel represented by the color image data.

13. The computer-readable storage device of claim 10,
wherein the processing operation further comprises:
a third step of generating the color image data constituted by color components of Y, M, and C from original color image data constituted by color components of Red (R), Green (G), Blue (B); and
wherein the third step is executed preceding to the first functional step.
